(19) United States
(12) Patent Application Publication
(10) Pub. No.: US 2025/0164825 A1
(43) Pub. Date: May 22, 2025

(54) EYEGLASSES AND HIGH-CONTRAST LENS

(71) Applicant: ASWAN INTERNATIONAL CORP., TAIPEI CITY (TW)

(72) Inventors: CHIA-HAU LIN, TAIPEI CITY (TW); Tzer-An Hung, Taipei city (TW)

(21) Appl. No.: 18/594,090

(22) Filed: Mar. 4, 2024

(30) Foreign Application Priority Data
Nov. 20, 2023 (TW) 112144704

(51) Int. Cl. G02C 7/10

(52) U.S. Cl. CPC G02C 7/104

(57) ABSTRACT

Eyeglasses and a high-contrast lens are respectively provided. The lens has a characteristic transmission spectrum within a wavelength range between 380 nm and 780 nm, and the characteristic transmission spectrum has: a first transmission trough, a second transmission trough, and a third transmission trough. A wavelength position corresponding to a bottom of the first transmission trough is between 490 nm and 500 nm, and the first transmission trough has a first minimum transmission rate not greater than 30%. A wavelength position corresponding to a bottom of the second transmission trough is between 592 nm and 598 nm, and the second transmission trough has a second minimum transmission rate not greater than 30%. A wavelength position corresponding to a bottom of the third transmission trough is between 680 nm and 688 nm, and the third transmission trough has a third minimum transmission rate not less than 15%.

### CROSS-REFERENCE TO RELATED PATENT APPLICATION

This application claims the benefit of priority to Taiwan Patent Application No. 112144704, filed on Nov. 20, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a lens, and more particularly to eyeglasses and a high-contrast lens, which can improve perception of color for a user.

### BACKGROUND OF THE DISCLOSURE

The ability of humans to see objects relies on a photoreceptive system of the human eye being stimulated by different spectra of light emitted or reflected by objects, thus allowing perception of outline, shape, color, or size of an object. The trichromatic theory suggests that a variety of color tones and shades of grey can be produced by mixing the three primary colors of light, such as red, green, and blue.

Three types of nerve fibers are formed on the retina of a human eye. Each type of the nerve fibers stimulates a sensation of one primary color. When light acts on the retina, one type of the nerve fibers is particularly strongly stimulated. For example, light in the long-wavelength spectrum stimulates red, green, and blue nerve fibers simultaneously, but the stimulation of the red fibers is the strongest, causing the sensation of red. The light in the middle wavelength spectrum most strongly stimulates the green nerve fibers, causing the sensation of green. Short wavelength spectrum light can induce the sensation of blue. In the mixing of spectral colors, the mixed color is the result of three types of nerve fibers being stimulated to different degrees and in different ratios at the same time. A minimum intensity of spectral stimulation required to excite each person's nerve fibers is also known as a threshold. The lower the threshold is, the more sensitive the person is to color light. The higher the threshold is, the less sensitive the person is to color light.

Congenital color vision disorders are commonly known as color blindness, which is characterized by inability to distinguish various colors or a specific color in a natural spectrum. People with poor ability to distinguish colors are referred to as being color weak. Although they can see colors as normal people do, their ability to recognize colors is delayed.

In dim light, some color weak individuals are almost as impaired as those with color blindness, or have color vision fatigue, which is not easily distinguished from color blindness. Color blindness and color weakness are physiological defects. Most affected individuals can still see monochromatic light. However, the individuals are disturbed by the transitional colors of the three primary colors in the spectrum, thereby reducing an intensity of a monochromatic light stimulus on the nerve fibers.

Due to insufficient or weak stimulation of the three types of nerve fibers in the retina (e.g., the intensity of the stimulus on the patient's nerve fibers being weak or below their threshold), patients exhibit delayed, poor, or even lack of color recognition abilities. In other words, patients with color blindness or color weakness have a lower perception of colors.

### SUMMARY OF THE DISCLOSURE

In response to the above-referenced technical inadequacies, the present disclosure provides eyeglasses and a high-contrast lens, which can improve perception of color for a user.

In order to solve the above-mentioned problems, one of the technical aspects adopted by the present disclosure is to provide eyeglasses including two lenses, two temples, and a nose bridge portion. The two lenses are disposed to be spaced apart from each other. The two temples are respectively disposed on opposite sides of the two lenses. The nose bridge portion is arranged and connected between the two lenses. Each of the lenses has a characteristic transmission spectrum within a wavelength range between 380 nm and 780 nm, and the characteristic transmission spectrum has: a first transmission trough, a second transmission trough, and a third transmission trough. A first wavelength position corresponding to a bottom of the first transmission trough is between 490 nm and 500 nm, and the first transmission trough has a first minimum transmission rate of not greater than 30%. A second wavelength position corresponding to a bottom of the second transmission trough is between 592 nm and 598 nm, and the second transmission trough has a second minimum transmission rate of not greater than 30%. A third wavelength position corresponding to a bottom of the third transmission trough is between 680 nm and 688 nm, and the third transmission trough has a third minimum transmission rate of not less than 15%. The third minimum transmission rate is greater than the first minimum transmission rate, and a difference between the third minimum transmission rate and the first minimum transmission rate is not less than 15%.

In order to solve the above-mentioned problems, another one of the technical aspects adopted by the present disclosure is to provide a high-contrast lens that has a characteristic transmission spectrum within a wavelength range between 380 nm and 780 nm, and the characteristic transmission spectrum has a first transmission trough, a second transmission trough, and a third transmission trough. A first wavelength position corresponding to a bottom of the first transmission trough is between 490 nm and 500 nm, and the first transmission trough has a first minimum transmission rate of not greater than 30%. A second wavelength position corresponding to a bottom of the second transmission trough is between 592 nm and 598 nm, and the second transmission trough has a second minimum transmission rate of not greater than 30%. A third wavelength position corresponding to a bottom of the third transmission trough is between 680 nm and 688 nm, and the third transmission trough has a third minimum transmission rate of not less than 15%. The third minimum transmission rate is greater than the first minimum transmission rate, and a difference between the third minimum transmission rate and the first minimum transmission rate is not less than 15%.

Therefore, in the eyeglasses and the high-contrast lens provided by the present disclosure, by virtue of “the lens having a characteristic transmission spectrum within a wavelength range between 380 nm and 780 nm,” “the characteristic transmission spectrum having a first transmission trough, a second transmission trough, and a third transmission trough,” and “a first wavelength position corresponding to a bottom of the first transmission trough being between 490 nm and 500 nm, and the first transmission trough having a first minimum transmission rate of not greater than 30%; a second wavelength position corresponding to a bottom of the second transmission trough being between 592 nm and 598 nm, and the second transmission trough having a second minimum transmission rate of not greater than 30%; a third wavelength position corresponding to a bottom of the third transmission trough being between 680 nm and 688 nm, and the third transmission trough having a third minimum transmission rate of not less than 15%; and the third minimum transmission rate being greater than the first minimum transmission rate, and a difference between the third minimum transmission rate and the first minimum transmission rate being not less than 15%,” the high-contrast lens of the eyeglasses can enhance color perception for a user, and is particularly beneficial for those with color blindness or color vision deficiencies.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective view of glasses according to a first embodiment of the present disclosure;

FIG. 2A shows a characteristic transmission spectrum of a lens of the glasses according to the first embodiment of the present disclosure;

FIG. 2B shows a variant of the characteristic transmission spectrum of the lens from FIG. 2A;

FIG. 2C shows a characteristic transmission spectrum of a lens of the glasses according to a second embodiment of the present disclosure;

FIG. 2D shows a variant of the characteristic transmission spectrum of the lens from FIG. 2C;

FIG. 2E to FIG. 2H show other variants of the characteristic transmission spectra of the lenses of the present disclosure;

FIG. 3A is a schematic view of a color gamut of the lens according to the first embodiment of the present disclosure;

FIG. 3B is a schematic view showing a variant of the color gamut of the lens from FIG. 3A;

FIG. 3C is a schematic view of a color gamut of the lens according to the second embodiment of the present disclosure;

FIG. 3D is a schematic view showing a variant of the color gamut of the lens from FIG. 3C;

FIG. 3E to FIG. 3G show other variants of the color gamuts of the lenses of the present disclosure;

FIG. 4 is a schematic view of the lens being provided with a polarizing plate according to the second embodiment of the present disclosure; and

FIG. 5 and FIG. 6 are schematic views showing other variants of the glasses according to other embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

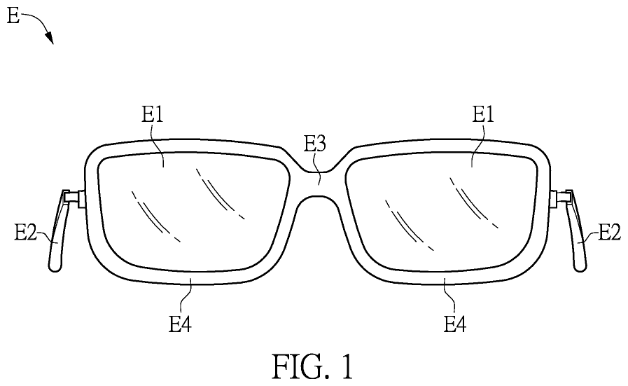

Referring to FIG. 1, a first embodiment of the present disclosure provides eyeglasses E (i.e., a pair of eyeglasses) that include two lenses E1, two temples E2, and a nose bridge portion E3. The two lenses E1 are disposed to be spaced apart from each other. The two temples E2 are respectively disposed on opposite sides of the two lenses E1. The nose bridge portion E3 is arranged and connected between the two lenses E1.

In the present embodiment, the eyeglasses E further include: two frames E4, and the two frames E4 are used to respectively fix the two lenses E1, but the present disclosure is not limited thereto.

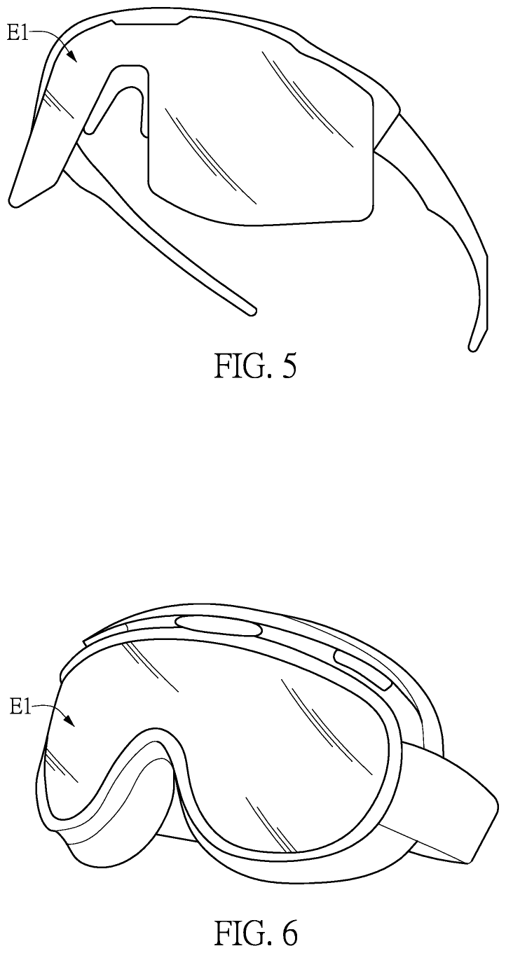

It is worth mentioning that the lenses E1 of the present disclosure are not limited to being applied on the eyeglasses E as shown in FIG. 1. The lenses E1 of the present disclosure can also be applied, for example, on goggles as shown in FIG. 5, or on ski goggles as shown in FIG. 6. In other words, the two lenses E1 shown in FIG. 1 are two separate components, but the present disclosure is not limited thereto. As shown in FIG. 5 or FIG. 6, the two lenses E1 can be directly connected to each other through a middle connection portion to have an integrated structure. In addition, as shown in FIG. 6, the two temples E2 can be replaced by a fixed band (not labeled) that can be fixed to the head of a user. The fixed band has two fixed ends respectively arranged on opposite sides of the two lenses E1, but the present disclosure is not limited thereto.

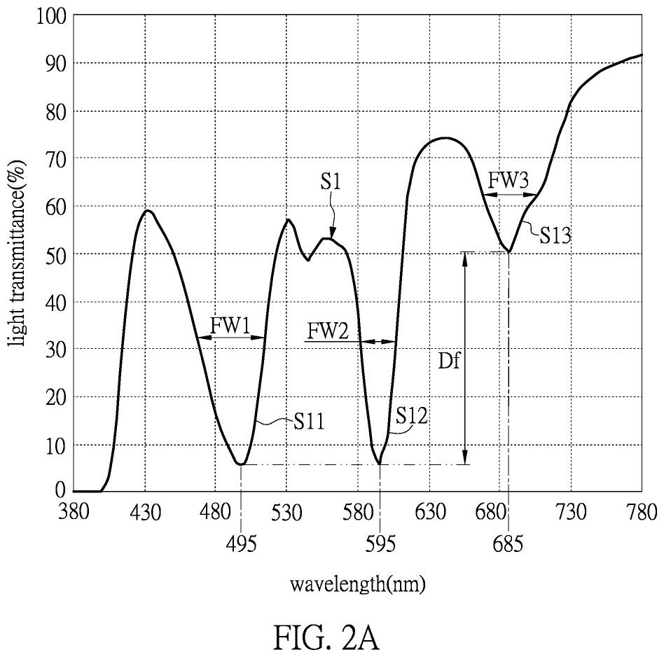

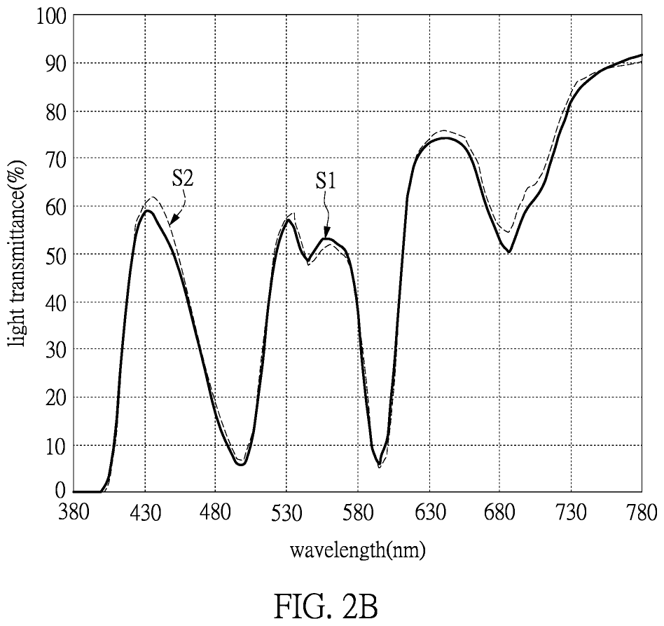

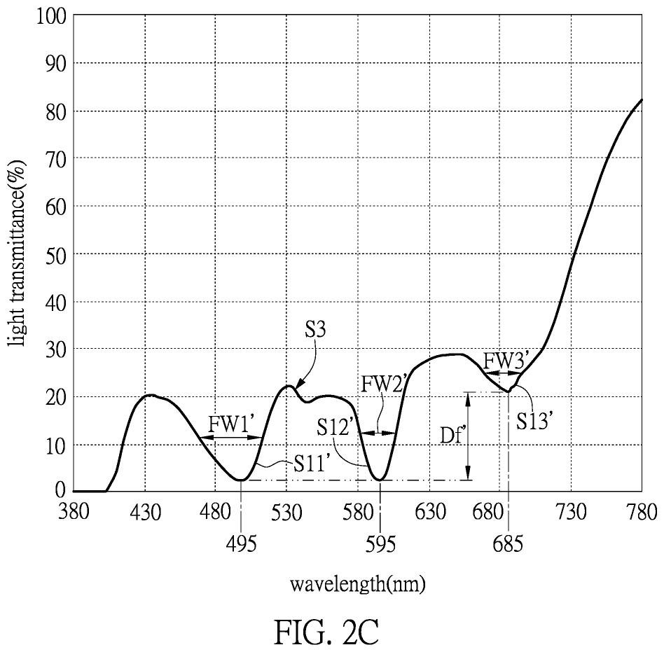

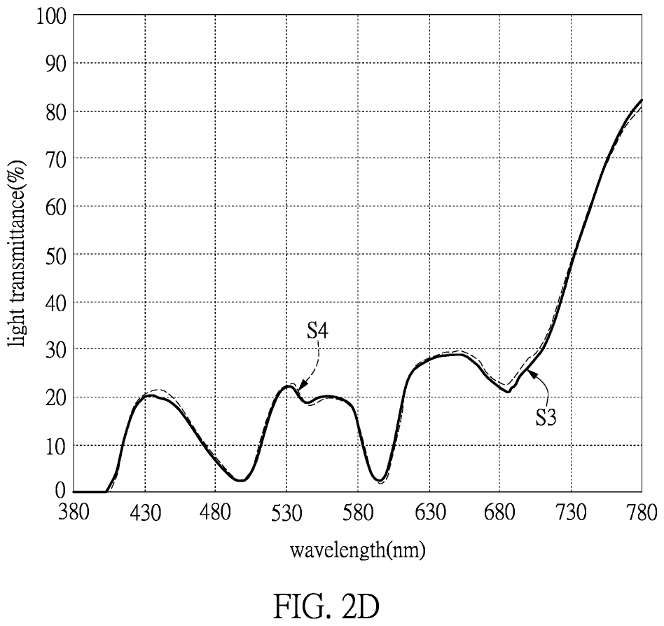

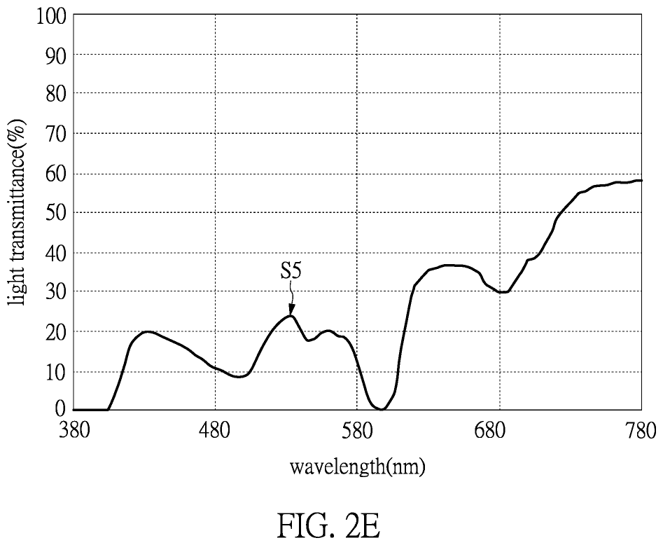

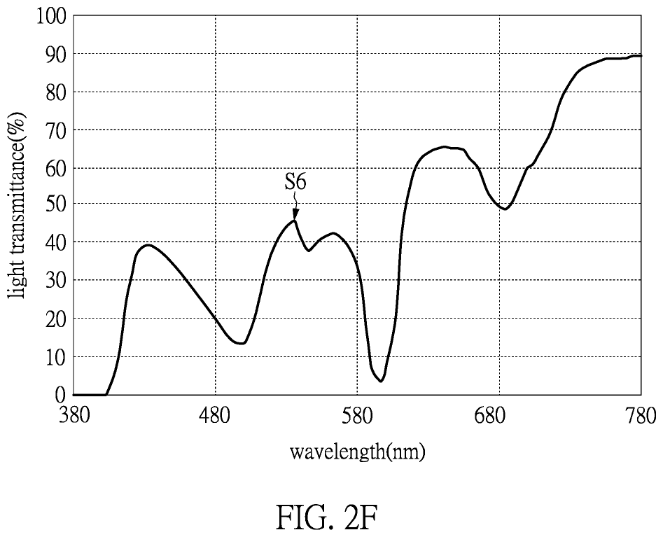

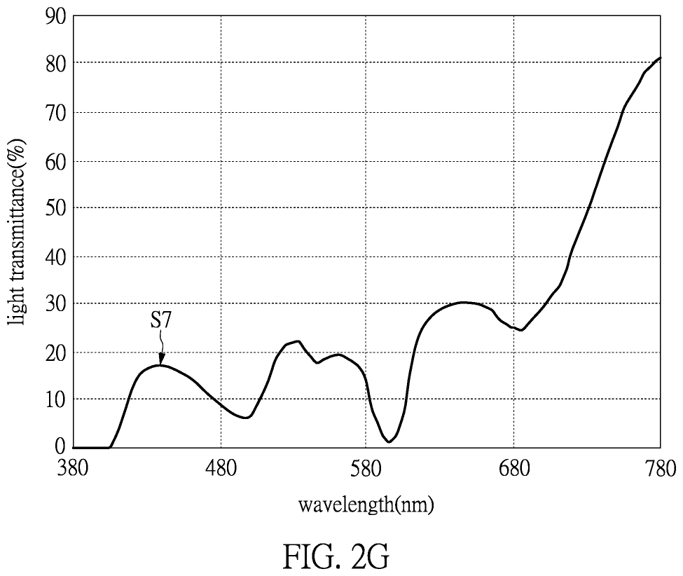

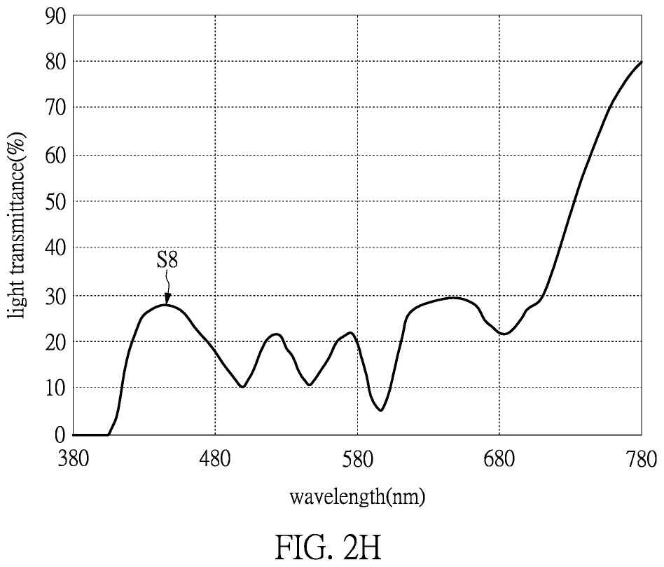

Referring to FIG. 2A, in the present embodiment, the lens E1 has specific optical characteristics.

More specifically, the lens E1 has a characteristic transmission spectrum S1 within a wavelength range of between 380 nm (nanometers) and 780 nm.

The characteristic transmission spectrum S1 has at least a first transmission trough S11 (also referred to as a first absorption peak), a second transmission trough S12 (also referred to as a second absorption peak), and a third transmission trough S13 (also referred to as the third absorption peak).

It is worth mentioning that, in the present embodiment, the characteristic transmission spectrum S1 of the lens E1 can be measured, for example, by a transmittance measuring instrument (e.g., a linear transmittance meter).

Furthermore, a first wavelength position corresponding to a bottom of the first transmission trough S11 is between 490 nm and 500 nm, and preferably between 493 nm and 497 nm. Specifically, the first wavelength position corresponding to the bottom of the first transmission trough S11 is 495 nm, but the present disclosure is not limited thereto. The bottom of the first transmission trough S11 has a first minimum transmission rate of not greater than 30%, preferably not greater than 15%, and more preferably not greater than 10%. In addition, a first half-trough full width FW1 of the first transmission trough S11 is not greater than 65 nm, and is preferably between 30 nm and 65 nm. It is worth mentioning that, the term “half-trough full width” referred in the present embodiment is defined as a distance between two points at a half-depth position of a transmission trough within its descending waveform. Alternatively, the half-trough full width can also be defined as a full width at half maximum (FWHM) of an absorption peak, offering an equivalent characterization in terms of light absorption.

In the present embodiment, the lens E1 can, for example, include a first narrow-band dye dispersed therein, and the first narrow-band dye has a first peak absorption wavelength in a first spectral band of between 490 nm and 500 nm (specifically at 495 nm). Accordingly, the characteristic transmission spectrum S1 of the lens E1 has the first transmission trough S11, but the present disclosure is not limited thereto.

In addition, it is worth noting that the term “narrow-band dyes” mentioned in the present embodiment refers to a dye with an optical density spectrum having a half-trough full width of 65 nanometers or less around a specific peak absorption wavelength. Each of the narrow-band dyes has an exclusive organic chemical formulation. The narrow-band dyes can be commercially available narrow-band dyes or laboratory-prepared dyes. As long as the dye meets the aforementioned characteristics, it falls within the spirit and scope of the present disclosure.

Furthermore, a second wavelength position corresponding to a bottom of the second transmission trough S12 is between 592 nm and 598 nm, and preferably between 594 nm and 596 nm. Specifically, the second wavelength position corresponding to the bottom of the second transmission trough S12 is 595 nm, but the present disclosure is not limited thereto.

The bottom of the second transmission trough S12 has a second minimum transmission rate of not greater than 30%, preferably not greater than 15%, and more preferably not greater than 10%.

In addition, a second half-trough full width FW2 of the second transmission trough S12 is less than the first half-trough full width FW1 of the first transmission trough S11.

In the present embodiment, the second half-trough full width FW2 of the second transmission trough S12 is not greater than 50 nm, and is preferably between 15 nm and 50 nm. In addition, the second half-trough full width FW2 is approximately 25% to 75%, and is more preferably 35% to 65% of the first half-trough full width FW1.

In the present embodiment, the lens E1 can, for example, further include a second narrow-band dye dispersed therein, and the second narrow-band dye has a second peak absorption wavelength in a second spectral band of between 592 nm and 598 nm (specifically at 595 nm). Accordingly, the characteristic transmission spectrum of the lens E1 has the second transmission trough S12, but the present disclosure is not limited thereto.

Furthermore, a third wavelength position corresponding to a bottom of the third transmission trough S13 is between 680 nm and 688 nm, and preferably between 684 nm and 686 nm. Specifically, the third wavelength position corresponding to the bottom of the third transmission trough S13 is 685 nm.

The bottom of the third transmission trough S13 has a third minimum transmission rate of not less than 15%, and preferably not less than 18%. More preferably, the bottom of the third transmission trough S13 has the third minimum transmission rate of not less than 48%, and particularly between 48% and 60%. Specifically, the third minimum transmission rate of the third transmission trough S13 is approximately 50%.

From another perspective, the third minimum transmission rate of the third transmission trough S13 (e.g., 48% to 60%) is greater than the first minimum transmission rate of the first transmission trough S11 (e.g., not greater than 10%), and a difference Df between the third minimum transmission rate and the first minimum transmission rate is not less than 15%, preferably not less than 40%, and more preferably between 40% and 60%.

A third half-trough full width FW3 of the third transmission trough S13 is not greater than 65 nm, and is preferably between 30 nm and 60 nm.

Further, the third half-trough full width FW3 is approximately 80% to 120% of the first half-trough full width FW1.

In the present embodiment, the lens E1 can, for example, further include a third narrow-band dye dispersed therein, and the third narrow-band dye has a third peak absorption wavelength in a third spectral band of between 680 nm and 688 nm (specifically at 685 nm). Accordingly, the characteristic transmission spectrum of the lens E1 has the third transmission trough S13, but the present disclosure is not limited thereto.

Furthermore, the characteristic transmission spectrum S1 of the lens E1 further has a first transmission peak (not labeled, the top of the first transmission peak being approximately located at a wavelength of 425 nm to 435 nm and having a maximum light transmittance of between 55% and 65%), a second transmission peak (not labeled, the top of the second transmission peak being approximately located at a wavelength of 528 nm to 535 nm and having a maximum light transmittance of between 53% and 63%), and a third transmission peak (not labeled, the top of the third transmission peak being approximately located at a wavelength of 630 nm to 650 nm and having a maximum light transmittance of between 70% and 80%). The first transmission trough S11 is located between the first transmission peak and the second transmission peak, and the second transmission trough S12 is located between the second transmission peak and the third transmission peak, but the present disclosure is not limited thereto.

In some embodiments of the present disclosure, the entirety or at least one functional layer of the lens E1 can be formed, for example, by injection molding a lens composition that includes dyes or pigments (e.g., the aforementioned first narrow-band dye, second narrow-band dye, and third narrow-band dye) capable of absorbing narrow wavebands with a polymer resin (e.g., polycarbonate, PC).

In some embodiments of the present disclosure, the polymer resin can be selected from the group consisting of polycarbonate, cellulose triacetate, polyamide, thermoplastic polyurethane, and polymethyl methacrylate (PMMA), but the present disclosure is not limited thereto.

In the lens composition, the first narrow-band dye, which absorbs visible light in the 490 nm to 500 nm wavelength range, is dispersed in the polymer resin (e.g., polycarbonate) in an amount of 0.010 to 0.040 grams of the first narrow-band dye per kilogram of the polymer resin. The second narrow-band dye, which absorbs visible light in the 592 nm to 598 nm wavelength range, is dispersed in the polymer resin in an amount of 0.030 to 0.060 grams of the second narrow-band dye per kilogram of the polymer resin. Additionally, the third narrow-band dye, which absorbs visible light in the 680 nm to 688 nm wavelength range, is dispersed in the polymer resin in an amount of 0.007 to 0.025 grams of the third narrow-band dye per kilogram of the polymer resin.

By adjusting the amounts of the aforementioned narrow-band dyes and selectively pairing with a polarizing plate E5, the characteristic transmission spectrum of the lens E1 can be modified.

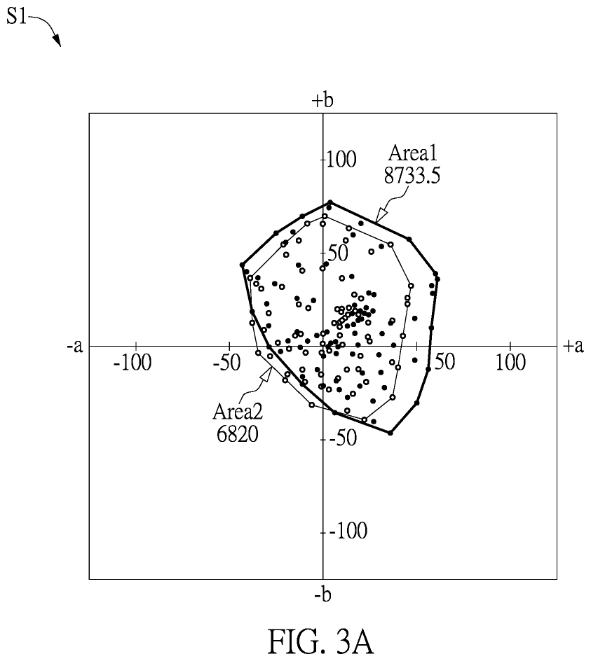

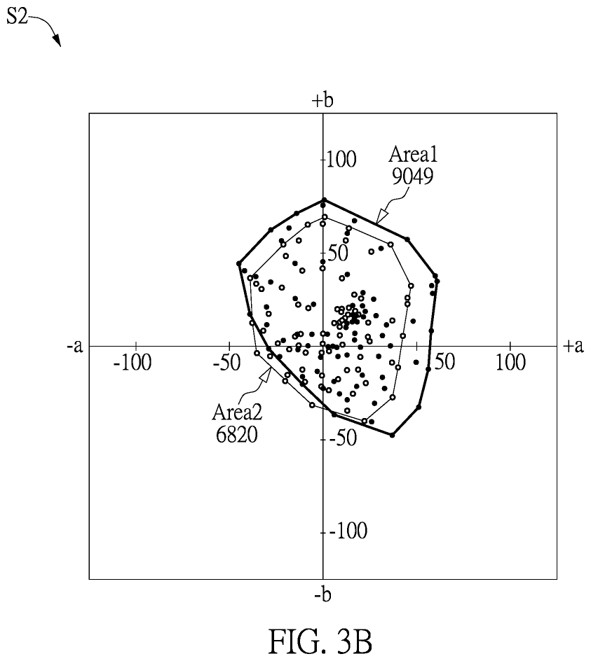

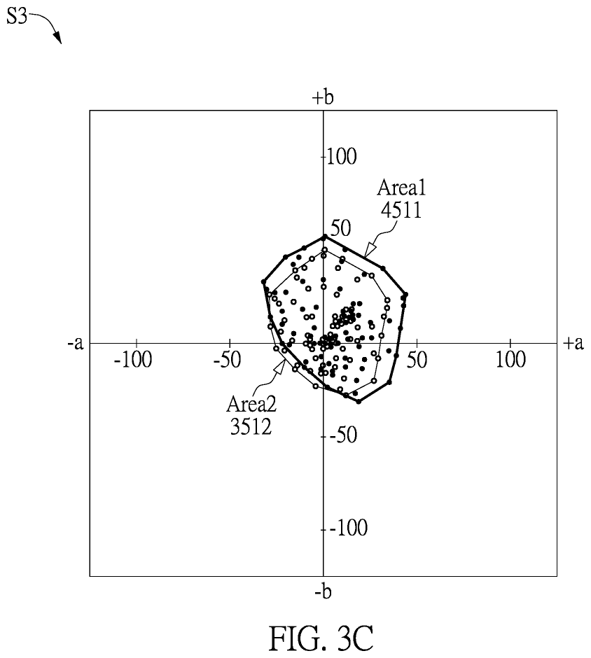

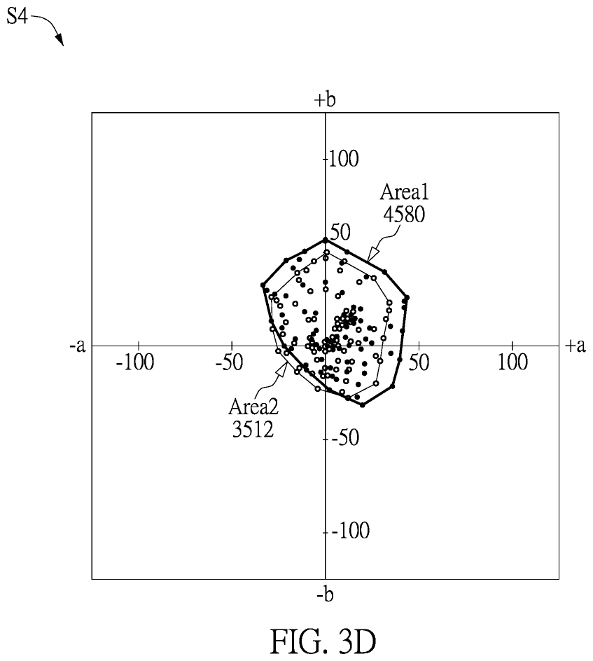

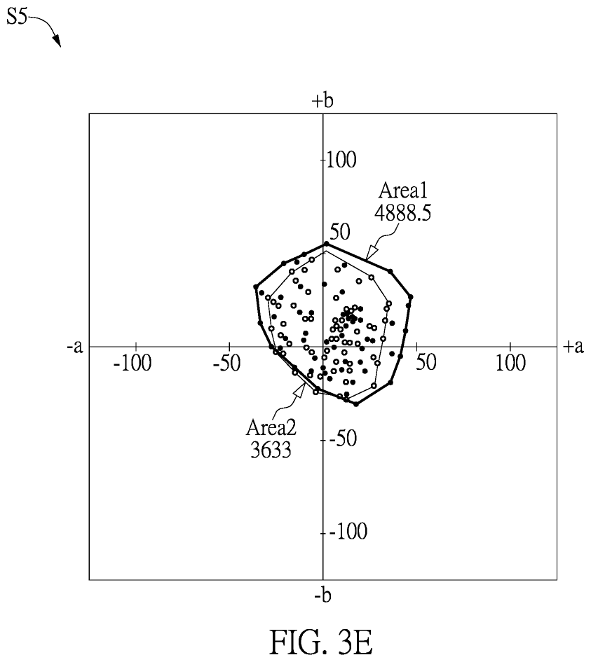

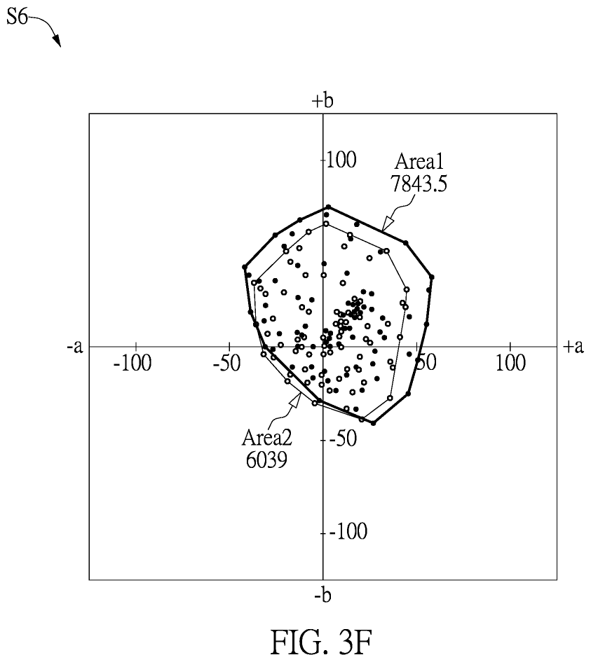

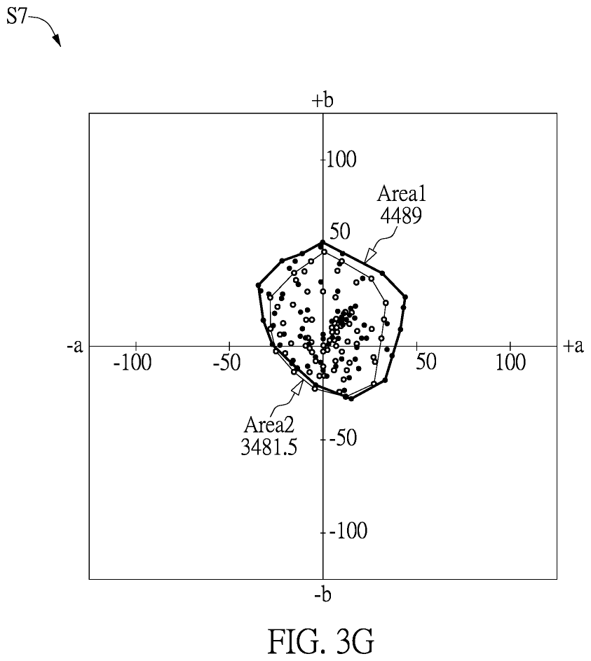

Further, as shown in FIG. 3A, the lens E1 of the present embodiment having the characteristic transmission spectrum S1 further has a color gamut extension of between 25% and 35%, preferably between 28% and 33%, and more preferably between 28.04% and 32.68%. The color gamut extension of the lens E1 is obtained by: irradiating the lens E1 of the present embodiment having the characteristic transmission spectrum S1 with a CIE standard illuminant D65 and calculating a first color gamut area Area 1 of the lens E1; then dividing the first color gamut area Area 1 by a second color gamut area Area 2, which is calculated from a colorless transparent lens under the irradiation of the CIE standard illuminant D65, to obtain a resulting ratio (i.e., Area 1/Area 2) expressed as percentage; and then subtracting the resulting ratio by 100%. Accordingly, the color gamut extension of the lens E1 of the present embodiment is defined.

In the present embodiment, the preparation method of the colorless transparent lens is the same as that of the lens E1 of the present embodiment having the characteristic transmission spectrum S1. The difference is that the colorless transparent lens only contains a polymer resin (e.g., polycarbonate) and does not contain the aforementioned first narrow-band dye, second narrow-band dye, third narrow-band dye, and any other dyes.

More specifically, the color gamut extension of the lens E1 of the present embodiment is measured by step a1, step a2, step a3, and step a4.

Step a1 includes: performing spectral measurement on n color standard cards covering an entire range of hues under a two-degree viewing angle using a CIE standard illuminant D65.

Step a2 includes: utilizing the spectra obtained in the step a1 to further determine a color space of the n color standard cards covering the entire range of hues, with a CIE LAB color space serving as a reference standard.

Step a3 includes: using the lens E1 of the present embodiment (having the characteristic transmission spectrum S1) and a colorless transparent lens (without the addition of the aforementioned first narrow-band dye, second narrow-band dye, and third narrow-band dye) to conduct the measurements as per step a1 and step a2 separately, so as to obtain two additional groups of CIE LAB color space values for the n color standard cards that cover the entire range of hues, resulting in the plotting of multiple points as shown in FIG. 3A.

Step a4 includes: calculating a first color gamut area Area1 surrounded by the largest convex points corresponding to the lens E1 the the present embodiment (i.e., the color gamut area of the lens E1 the the present embodiment) and a second color gamut area Area2 surrounded by the largest convex points corresponding to the colorless transparent lens (i.e., the color gamut area of the colorless transparent lens) based on the a and b axes of the CIE LAB color space for the n color cards from step a3; and then defining the color gamut extension of the lens E1 by dividing Area1 by Area2 (i.e., Area1/Area2) to obtain a resulting ratio, which is expressed as percentage; and then subtracting the resulting ratio by 100%. Accordingly, the color gamut extension of the lens E1 of the present embodiment is defined.

Specifically, as shown in FIG. 3A, the first color gamut area Area1 of the first embodiment ranges between 8,500 and 9,500 (specifically 8,733.5), and the second color gamut area Area2 ranges between 6,500 and 7,000 (specifically 6,820). Accordingly, the calculation of the color gamut extension of the lens E1 of the first embodiment is done by dividing 8,733.5 by 6,820, and then subtracting 100%, resulting in the color gamut extension of 28.06% for the lens E1 of the first embodiment.

According to the above configuration, the lens E1 of the present embodiment has the specific characteristic transmission spectrum S1 and exhibits a color gamut extension of 25% to 35%. Therefore, the lens E1 of the present embodiment can have a relatively high contrast and enhance color perception for a user.

As shown in FIG. 2B, FIG. 2B shows a variant embodiment of the characteristic transmission spectrum S1 of the lens E1 from FIG. 2A. The characteristic transmission spectrum S2 of the lens E1 of FIG. 2B is similar in waveform to the characteristic transmission spectrum S1 of the lens E1 of FIG. 2A. The main difference is that the characteristic transmission spectrum S2 of the lens E1 of FIG. 2B has a shallower depression depth at its third transmission trough S13 (located between 680 nm and 688 nm) than that of the lens E1 of FIG. 2A.

Specifically, the third minimum transmission rate (i.e., the light transmittance at the wavelength of 685 nanometers) of the third transmission trough S13 of the characteristic transmission spectrum S1 of the lens E1 of FIG. 2A is approximately 50%.

Further, the third minimum transmission rate of the third transmission trough S13 of the characteristic transmission spectrum S2 of the lens E1 of FIG. 2B is approximately 55%, which represents an approximate 5% increase compared to that of the characteristic transmission spectrum S1 of the lens E1 of FIG. 2A. That is, the characteristic transmission spectrum S2 has approximate 5% increase of transmittance at the wavelength of 685 nanometers than that of the characteristic transmission spectrum S1.

As shown in FIG. 3B, based on the characteristic transmission spectrum S2 of the lens E1 of FIG. 2B, the first color gamut area Area1 of the lens E1 is 9,049. The second color gamut area Area2 of the colorless transparent lens is 6,820.

Accordingly, the calculation of the color gamut extension of the lens E1 of FIG. 3B is done by dividing 9,049 by 6,820 to obtain a resulting ratio (expressed as percentage), and then subtracting the resulting ratio by 100%, which results in the color gamut extension of 32.68% for the lens E1 relative to the colorless transparent lens.

In other words, adjusting the characteristic transmission spectrum S1, S2 of the lens E1 can adjust the color gamut area of the lens E1 (i.e., the first color gamut area Area1) and adjust the degree of the color gamut extension.

### Second Embodiment

A second embodiment of the present disclosure provides eyeglasses E, which are similar to that of the first embodiment as mentioned above.

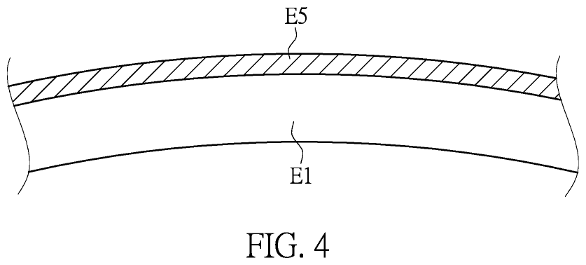

As shown in FIG. 4, the main difference of the second embodiment compared to the first embodiment is that the eyeglasses E further include a polarizing plate E5 disposed on each of the lenses E1.

Specifically, the eyeglasses E of the second embodiment further include two polarizing plates E5 that are respectively positioned and adhered on the two lenses E1.

As shown in FIG. 2C, in the second embodiment, the lens E1 has a specific optical characteristics.

More specifically, the lens E1 of the second embodiment has another characteristic transmission spectrum S3 within a wavelength range of between 380 nm and 780 nm. The characteristic transmission spectrum S3 has at least a first transmission trough S11′, a second transmission trough S12′, and a third transmission trough S13′.

Due to the incorporation of the polarizing plate E5 onto the lens E1, the characteristic transmission spectrum S3 of the lens of the second embodiment has a lower average transmittance within the wavelength range of between 380 nm and 780 nm compared to the characteristic transmission spectrum S1 of the lens of the first embodiment, but the present disclosure is not limited thereto. For example, to reduce the average light transmittance of the lens, more pigments or dyes can be added to the lens to achieve the same technical objective. In such cases, there would be no need to equip the lens with the polarizing plate.

Furthermore, a first wavelength position corresponding to a bottom of the first transmission trough S11′ is between 490 nm and 500 nm, and preferably between 493 nm and 497 nm. For example, the first wavelength position corresponding to the bottom of the first transmission trough S11′ is 495 nm. The bottom of the first transmission trough S11′ has a first minimum transmission rate of not greater than 10%, and preferably not greater than 6%. In addition, a first half-trough full width FW1′ of the first transmission trough S11′ is not greater than 65 nm, and is preferably between 30 nm and 65 nm.

In the present embodiment, the lens E1 can, for example, include a first narrow-band dye dispersed therein, and the first narrow-band dye has a first peak absorption wavelength in a first spectral band of between 490 nm and 500 nm (specifically at 495 nm). In addition, the lens E1 is provided with the polarizing plate E5. Accordingly, the characteristic transmission spectrum S3 of the lens E1 has the first transmission trough S11′.

Furthermore, a second wavelength position corresponding to a bottom of the second transmission trough S12′ is between 592 nm and 598 nm, and preferably between 594 nm and 596 nm. Specifically, the second wavelength position corresponding to the bottom of the second transmission trough S12′ is 595 nm, but the present disclosure is not limited thereto. The bottom of the second transmission trough S12′ has a second minimum transmission rate of not greater than 10%, and preferably not greater than 6%.

In addition, a second half-trough full width FW2′ of the second transmission trough S12′ is less than the first half-trough full width FW1′ of the first transmission trough S11′. In the present embodiment, the second half-trough full width FW2′ of the second transmission trough S12′ is not greater than 50 nm, and is preferably between 15 nm and 50 nm. In addition, the second half-trough full width FW2′ is approximately 25% to 75%, and is more preferably 35% to 65% of the first half-trough full width FW1′, but the present disclosure is not limited thereto.

In the present embodiment, the lens E1 can, for example, further include a second narrow-band dye dispersed therein, and the second narrow-band dye has a second peak absorption wavelength in a second spectral band of between 592 nm and 598 nm (specifically at 595 nm). In addition, the lens E1 is provided with the polarizing plate E5. Accordingly, the characteristic transmission spectrum S3 of the lens E1 has the second transmission trough S12′, but the present disclosure is not limited thereto.

Furthermore, a third wavelength position corresponding to a bottom of the third transmission trough S13′ is between 680 nm and 688 nm, and preferably between 684 nm and 686 nm. Specifically, the third wavelength position corresponding to the bottom of the third transmission trough S13′ is 685 nm.

The bottom of the third transmission trough S13′ has a third minimum transmission rate of not less than 18%, and preferably not less than 20%. Specifically, the bottom of the third transmission trough S13′ has the third minimum transmission rate of between 20% and 25% (e.g., 21%).

From another perspective, a difference Df′ between the third minimum transmittance of the third transmission trough S13′ (e.g., between 20% and 25%) and the first minimum transmittance of the first transmission trough S11′ (e.g., not greater than 6%) is not less than 15%, and is preferably between 15% and 30%.

A third half-trough full width FW3′ of the third transmission trough S13′ is not greater than 40 nm, and is preferably between 10 nm and 40 nm.

In the present embodiment, the lens E1 can, for example, further include a third narrow-band dye dispersed therein, and the third narrow-band dye has a third peak absorption wavelength in a third spectral band of between 680 nm and 688 nm (specifically at 685 nm). In addition, the lens E1 is provided with the polarizing plate E5. Accordingly, the characteristic transmission spectrum S3 of the lens E1 has the third transmission trough $13′, but the present disclosure is not limited thereto.

Furthermore, as shown in FIG. 2C, the characteristic transmission spectrum S3 of the lens E1 further has a first transmission peak (not labeled, the top of the first transmission peak being approximately located at a wavelength of 428 nm to 435 nm and having a maximum light transmittance of between 18% and 25%), a second transmission peak (not labeled, the top of the second transmission peak being approximately located at a wavelength of 528 nm to 535 nm and having a maximum light transmittance of between 18% and 25%), and a third transmission peak (not labeled, the top of the third transmission peak being approximately located at a wavelength of 635 nm to 670 nm and having a maximum light transmittance of between 25% and 35%).

The first transmission trough S11′ is located between the first transmission peak and the second transmission peak, and the second transmission trough S12′ is located between the second transmission peak and the third transmission peak, but the present disclosure is not limited thereto.

Further, as shown in FIG. 3C, the lens E1 of the present embodiment having the characteristic transmission spectrum S3 further has a color gamut extension of between 25% and 35% (e.g., 28.44%).

In more detail, the color gamut extension of the lens E1 of the present embodiment is obtained by irradiating the lens E1 of the present embodiment having the characteristic transmission spectrum S3 with a CIE standard illuminant D65 and calculating a first color gamut area Area1 (e.g., 4,511) of the lens. The first color gamut area Area1 is compared to a second color gamut area Area2 (e.g., 3,512), which is calculated in the same way for a colorless transparent lens that includes a polymer resin and is provided with a polarizing plate, but does not contain the aforementioned narrow-band dyes. The color gamut extension is defined by dividing Area1 by Area2 to obtain a resulting ratio (i.e., Area 1/Area 2) expressed as percentage; and then subtracting the resulting ratio by 100%.

Accordingly, the color gamut extension of the lens E1 of the present embodiment is 28.44%. The specific method of calculating the color gamut extension has already been described in the first embodiment and will not be reiterated herein.

According to the above configuration, the lens E1 of the present embodiment has the specific characteristic transmission spectrum S3 and exhibits a color gamut extension of 25% to 35%. Therefore, the lens E1 of the present embodiment can have a relative high contrast and enhance color perception for a user.

As shown in FIG. 2D, FIG. 2D shows a variant embodiment of the characteristic transmission spectrum S3 of the lens E1 of FIG. 2C. The characteristic transmission spectrum S4 of the lens E1 of FIG. 2D is similar in waveform to the characteristic transmission spectrum S3 of the lens E1 of FIG. 2C. The main difference is that the characteristic transmission spectrum S4 of the lens E1 of FIG. 2D has a shallower depression depth at its third transmission trough S13′ (located between 680 nm and 688 nm) than that of the lens E1 of FIG. 2C.

Specifically, the third minimum transmission rate (i.e., the light transmittance at the wavelength of 685 nanometers) of the third transmission trough S13′ of the characteristic transmission spectrum S3 of the lens E1 of FIG. 2C is approximately 21%. Further, the third minimum transmission rate of the third transmission trough S13′ of the characteristic transmission spectrum S4 of the lens E1 of FIG. 2D is approximately 23%, which represents an approximate 2% increase compared to that of the characteristic transmission spectrum S3 of the lens E1 of FIG. 2C.

As shown in FIG. 3D, based on the characteristic transmission spectrum S4 of the lens E1 of FIG. 2D, the first color gamut area Area1 of the lens E1 is 4,580. The second color gamut area Area2 of the colorless transparent lens is 3,512.

Accordingly, the calculation of the color gamut extension of the lens E1 of FIG. 3D is done by dividing 4,580 by 3,512 to obtain a resulting ratio (expressed as percentage), and then subtracting the resulting ratio by 100%, which results in the color gamut extension of 30.04% for the lens E1 relative to the colorless transparent lens.

Further, the third minimum transmission rate of the characteristic transmission spectrum S5 of the lens E1 of FIG. 2E is approximately 30%, which is about 7% higher than the third minimum transmission rate (i.e., 23%) of the characteristic transmission spectrum S4 shown in FIG. 2D. As shown in FIG. 3E, based on the characteristic transmission spectrum S5 of the lens E1 of FIG. 2E, the first color gamut area Area1 of the lens E1 is 4,888.5. The second color gamut area Area2 of the colorless transparent lens is 3,633. Accordingly, the calculation of the color gamut extension for the lens E1 in FIG. 3E is done by dividing 4,888.5 by 3,633, and then subtracting 100%, resulting in a color gamut extension of 34.55% for the lens E1.

Furthermore, the third minimum transmission rate of the characteristic transmission spectrum S6 of the lens E1 of FIG. 2F, which only adds narrow-band dyes and does not have a polarizing plate, is approximately 48%.

As shown in FIG. 3F, based on the characteristic transmission spectrum S6 of the lens E1 of FIG. 2F, the first color gamut area Area1 of the lens E1 is 7,843.5, and the second color gamut area Area2 of the colorless transparent lens is 6,039. Accordingly, the color gamut extension for the lens E1 of FIG. 3F is 29.9%.

Furthermore, the third minimum transmission rate of the characteristic transmission spectrum S7 of the lens E1 of FIG. 2G, which is the lens from FIG. 2F further equipped with a polarizing plate or added with other broad-band dyes, is approximately 25%. As shown in FIG. 3G, based on the characteristic transmission spectrum S7 of the lens E1 of FIG. 2G, the first color gamut area Area1 of the lens E1 is 4,489, and the second color gamut area Area2 of the colorless transparent lens is 3,481.5. Accordingly, the color gamut extension for the lens E1 in FIG. 3G is 28.94%.

Furthermore, as illustrated in FIG. 3A to FIG. 3D, on the a and b axes of the CIE LAB color space, the color gamut of the lens E1 in each of the embodiments extends further in both the +a axis direction and the +b axis direction, with its maximum convex point values being greater than those of the colorless transparent lens. For example, the color gamut of the lens E1 in each of the embodiments extends at least 5 numerical points more in the +a axis direction and also at least 5 numerical points more in the +b axis direction compared to those of the colorless transparent lens.

It is worth mentioning that the characteristic transmission spectrum S1 to S7 of the lens E1 in each of the above-mentioned embodiments is illustrated as having three transmission troughs that include the first transmission trough (between 490 nm and 500 nm), the second transmission trough (between 592 nm and 598 nm), and the third transmission trough (between 680 nm and 688 nm), but the present disclosure is not limited thereto.

As shown in FIG. 2H, in a variant embodiment of the present disclosure, the characteristic transmission spectrum S8 of the lens E1 further includes a fourth transmission trough (not labeled) located between the first transmission trough (490 nm to 500 nm) and the second transmission trough (592 nm to 598 nm). The wavelength range corresponding to the bottom of the fourth transmission trough is between 535 nm and 570 nm. The lens E1 of FIG. 2H having the characteristic transmission spectrum S8 also exhibits a color gamut expansion of between 25% and 35%.

### Beneficial Effects of the Embodiments

In conclusion, in the eyeglasses and the high-contrast lens provided by the present disclosure, by virtue of “the lens having a characteristic transmission spectrum within a wavelength range between 380 nm and 780 nm,” “the characteristic transmission spectrum having a first transmission trough, a second transmission trough, and a third transmission trough,” and “a first wavelength position corresponding to a bottom of the first transmission trough being between 490 nm and 500 nm, and the first transmission trough having a first minimum transmission rate of not greater than 30%; a second wavelength position corresponding to a bottom of the second transmission trough being between 592 nm and 598 nm, and the second transmission trough having a second minimum transmission rate of not greater than 30%; a third wavelength position corresponding to a bottom of the third transmission trough being between 680 nm and 688 nm, and the third transmission trough having a third minimum transmission rate of not less than 15%; and the third minimum transmission rate being greater than the first minimum transmission rate, and a difference between the third minimum transmission rate and the first minimum transmission rate being not less than 15%,” the high-contrast lens of the eyeglasses can enhance color perception for a user, and is particularly beneficial for those with color blindness or color vision deficiencies.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. Eyeglasses, comprising:
two lenses disposed to be spaced apart from each other;
two temples respectively disposed on two opposite sides of the two lenses; and
a nose bridge portion arranged and connected between the two lenses;
wherein each of the lenses has a characteristic transmission spectrum within a wavelength range between 380 nm and 780 nm, and the characteristic transmission spectrum has:
a first transmission trough, wherein a first wavelength position corresponding to a bottom of the first transmission trough is between 490 nm and 500 nm, and the first transmission trough has a first minimum transmission rate of not greater than 30%;
a second transmission trough, wherein a second wavelength position corresponding to a bottom of the second transmission trough is between 592 nm and 598 nm, and the second transmission trough has a second minimum transmission rate of not greater than 30%; and
a third transmission trough, wherein a third wavelength position corresponding to a bottom of the third transmission trough is between 680 nm and 688 nm, and the third transmission trough has a third minimum transmission rate of not less than 15%;
wherein the third minimum transmission rate is greater than the first minimum transmission rate, and a difference between the third minimum transmission rate and the first minimum transmission rate is not less than 15%.

2. The eyeglasses according to claim 1, further comprising a polarizing plate disposed on each of the lenses.

3. A high-contrast lens, characterized in that the high-contrast lens has a characteristic transmission spectrum within a wavelength range between 380 nm and 780 nm, and the characteristic transmission spectrum has:
a first transmission trough, wherein a first wavelength position corresponding to a bottom of the first transmission trough is between 490 nm and 500 nm, and the first transmission trough has a first minimum transmission rate of not greater than 30%;
a second transmission trough, wherein a second wavelength position corresponding to a bottom of the second transmission trough is between 592 nm and 598 nm, and the second transmission trough has a second minimum transmission rate of not greater than 30%; and
a third transmission trough, wherein a third wavelength position corresponding to a bottom of the third transmission trough is between 680 nm and 688 nm, and the third transmission trough has a third minimum transmission rate of not less than 15%;
wherein the third minimum transmission rate is greater than the first minimum transmission rate, and a difference between the third minimum transmission rate and the first minimum transmission rate is not less than 15%.

4. The lens according to claim 3, wherein the lens having the characteristic transmission spectrum further has a color gamut extension of between 25% and 35%; wherein the color gamut extension of the lens is obtained by: irradiating the lens having the characteristic transmission spectrum with a CIE standard illuminant D65 and calculating a first color gamut area; then dividing the first color gamut area by a second color gamut area, which is calculated from a colorless transparent lens under the irradiation of the CIE standard illuminant D65, to obtain a resulting ratio expressed as percentage;
and then subtracting the resulting ratio by 100%.

5. The lens according to claim 4, wherein, on a-b axes of a CIE LAB color space, the lens having the characteristic transmission spectrum exhibits a color gamut that extends at least 5 numerical points greater than a maximum convex point value of the colorless transparent lens on either the +a axis or +b axis.

6. The lens according to claim 3, wherein the first wavelength position corresponding to the bottom of the first transmission trough is between 493 nm and 497 nm, the second wavelength position corresponding to the bottom of the second transmission trough is between 594 nm and 596 nm, and the third wavelength position corresponding to the bottom of the third transmission trough is between 684 nm and 686 nm.

7. The lens according to claim 6, wherein the first wavelength position corresponding to the bottom of the first transmission trough is 495 nm, the second wavelength position corresponding to the bottom of the second transmission trough is 595 nm, and the third wavelength position corresponding to the bottom of the third transmission trough is 685 nm.

8. The lens according to claim 3, wherein a first half-trough full width of the first transmission trough is not greater than 65 nm, a second half-trough full width of the second transmission trough is not greater than 50 nm, and a third half-trough full width of the third transmission trough is not greater than 65 nm; wherein the second half-trough full width is 25% to 75% of the first half-trough full width.

9. The lens according to claim 3, wherein a composition of the lens includes a first narrow-band dye, a second narrow-band dye, and a third narrow-band dye; wherein the first narrow-band dye has a first peak absorption wavelength in a first spectral band of between 490 nm and 500 nm, the second narrow-band dye has a second peak absorption wavelength in a second spectral band of between 592 nm and 598 nm, and the third narrow-band dye has a third peak absorption wavelength in a third spectral band of between 680 nm and 688 nm.

10. The lens according to claim 3, wherein the characteristic transmission spectrum of the lens further has a first transmission peak, a second transmission peak, and a third transmission peak; wherein a top of the first transmission peak is located at a wavelength of between 425 nm and 435 nm, a top of the second transmission peak is located at a wavelength of between 528 nm and 535 nm, and a top of the third transmission peak is located at a wavelength of between 630 nm and 670 nm; wherein the first transmission trough is located between the first transmission peak and the second transmission peak, and the second transmission trough is located between the second transmission peak and the third transmission peak.
